(19) United States
(12) Patent Application Publication
(10) Pub. No.: US 2015/0298315 A1
(43) Pub. Date: Oct. 22, 2015

(54) METHODS AND SYSTEMS TO FACILITATE CHILD DEVELOPMENT THROUGH THERAPEUTIC ROBOTICS

(71) Applicant: Origami Robotics, Inc., Berkeley, CA (US)

(72) Inventors: Aubrey A. Shick, Berkeley, CA (US); Jared William Peters, Oakland, CA (US)

(21) Appl. No.: 14/550,567

(22) Filed: Nov. 21, 2014

Related U.S. Application Data
(60) Provisional application No. 61/907,366, filed on Nov. 21, 2013.
(60) Provisional application No. 61/981,017, filed on Apr. 17, 2014.

(51) Int. Cl. B25J 9/00; G06N 3/00; G10L 13/00

(52) U.S. Cl. CPC B25J 9/0003; G10L 13/00; G06N 3/008

(57) ABSTRACT

Some embodiments include a robot that may be used to facilitate education and/or therapy. The robot can include a head section configured to interface with a mobile device to control the robot. The robot can also include a tail section having a movement device controlled by the mobile device and a battery to power the movement device. The robot can have a furry exterior to emulate an intelligent pet. A remote controller can communicate with the mobile device to communicate or activate lesson or therapy commands. The remote controller can provide a design interface to configure the lesson or therapy commands.

### CROSS REFERENCE

This application claims the benefit of U.S. Provisional Patent Application No. 61/907,366, entitled “DATA DELIVERY AND STORAGE SYSTEM FOR THERAPEUTIC ROBOTICS,”, filed Nov. 21, 2013 and U.S. Provisional Patent Application No. 61/981,017, entitled “METHODS AND SYSTEMS TO FACILITATE CHILD DEVELOPMENT THROUGH THERAPEUTIC ROBOTICS, filed Apr. 17, 2014, both of which are incorporated by reference herein in their entirety.

### RELATED FIELD

This disclosure relates generally to child development tools, and in particular to use of therapeutic robots for child development.

### BACKGROUND

Traditional developmental therapy involves monitoring a child in a controlled environment to establish a baseline diagnosis of the child. Based on the diagnosis, behavioral corrections and therapeutic exercises are designed to facilitate a healthier developmental path for the child. Because of the difficulty of monitoring the child in his or her natural environment, the baseline diagnosis often times may deviate from an actual developmental state of the child. Similarly, when the therapeutic exercises are designed for a controlled environment, the therapeutic exercises suffer the same problem where the corrections are not done in the child's natural environment.

### BRIEF DESCRIPTION OF THE DRAWINGS

FIG. 1 is an illustrative diagram of a therapeutic robot, in accordance with various embodiments.

FIG. 2 is a data flow chart of a developmental monitoring system, in accordance with various embodiments.

FIG. 3 is flow chart of a process of storing data reported from a therapeutic robot, in accordance with various embodiments.

FIG. 4 is a diagrammatic representation of a machine in the example form of a computer system within which a set of instructions, for causing the machine to perform any one or more of the methodologies or modules discussed herein, may be executed.

FIG. 5 is a block diagram illustrating a system architecture of a therapeutic robotics system.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Disclosed is a system involving a therapeutic robot acting as an agent (i.e., a seemingly autonomous and intelligent being) of a “guiding operator” (e.g., a therapist, a teacher, a counselor, a guardian or parent, etc.) who wants to understand and help a child to develop. The disclosed system overcomes the challenges of traditional developmental-related programs by providing a predictable second channel of communication between a child and the guiding operator. For example, while a child may be fearful of a guiding operator in a direct one-on-one session, a child tends not to be fearful of interactions with a therapeutic robot. This holds true even when the child realizes that the guiding operator is puppeteering the therapeutic robot. Involvement of the therapeutic robot may also be superior to having another child as the guiding operator's agent, because of the robot's predictability over the other child.

Embodiments include a therapeutic robot that can inspire trust from children in a way that another human being, particularly an adult, cannot. For example, the therapeutic robot is sized such that the robot is small enough to appear non-threatening (e.g., smaller, weaker, or slower than most children). The therapeutic robot is also sized such that the robot is large enough to appear as a plausible intelligent agent (e.g., at least the size of intelligent pets or other human children). In embodiments, the therapeutic robot is donned with a furry exterior to emulate an intelligent pet.

The disclosed system provides an environment to facilitate training and therapy sessions and lessons where a child would not otherwise feel comfortable if other humans, particularly adult humans, were involved. For example, the disclosed system enables a guiding operator to monitor, educate, motivate, encourage, bond, play, engage, or teach a child through engaging exercises via the therapeutic robot. Expert therapists, counselors, or teachers can gather information in a new way and engage with children in a new way through the therapeutic robot. The disclosed therapeutic robot can inspire trust from a child because of its size (e.g., as described above), its non-threatening demeanor, its consistency, its behavioral simplicity, its adorable appearance, its predictability, its human-like nature (e.g., because it is puppeteered by a person), and etc.

In some embodiments, the disclosed therapeutic robot is designed without an artificial intelligence that reacts to a child either systematically or in a non-human way. If the disclosed therapeutic robot's interactions with a child depends on an artificial intelligence, then the disclosed system would be reinforcing behaviors in the child that are inconsistent with a healthy, social individual. Accordingly, the disclosed therapeutic robot includes a set of tools that facilitates an expert guiding operator to interact with children through the therapeutic robot. In these embodiments, the therapeutic robot only emulates limited systematic behaviors to uphold a visage of intelligent agency.

In various embodiments, the robot is controlled by an internal mobile device (e.g., an iPhone™ or iPod Touch™). The internal mobile device can, in turn, be controlled externally by a control device, such as a tablet or a laptop. For example, the internal mobile device can facilitate emulation of an intelligent agent by controlling electric and mechanical components, such as actuators, motors, speakers, displays, and/or sensors in the therapeutic robot. These mechanical components can enable the robot to gesture, move, and behave like a human or at least an intelligent animal. In some embodiments, a portion of the actuators, motors, speakers, displays, and/or sensors are external to the internal mobile device and are controlled by the internal mobile device wirelessly (e.g., via Bluetooth LE) or by wired connections. The sensors (e.g., one or more microphones, one or more cameras, one or more accelerometers, one or more thermometers, or one or more tactile sensors) can record behavioral data in relations to a child's interaction with the therapeutic robot. The one or more actuators, motors, speakers, and displays in the therapeutic robot can execute pre-programmed behaviors to emulate an intelligent agent. The one or more actuators, motors, speakers, and displays can also execute commands from the control device.

The therapeutic robot may include a head section and a foot section. The internal mobile device can be located inside the head section. For example, the display of the internal mobile device can represent a portion of the therapeutic robot's face. In various embodiments, the internal mobile device is portable and detachable from the therapeutic robot.

The disclosed system also includes modules within the control device that enable a guiding operator to design behaviors of the therapeutic robot according to specific context, such as teaching opportunities, specific situations, lessons, and exercises. The control device also includes modules and toolkits to execute the lessons and exercises, including real-time monitoring, real-time data collection, and real-time puppeteering.

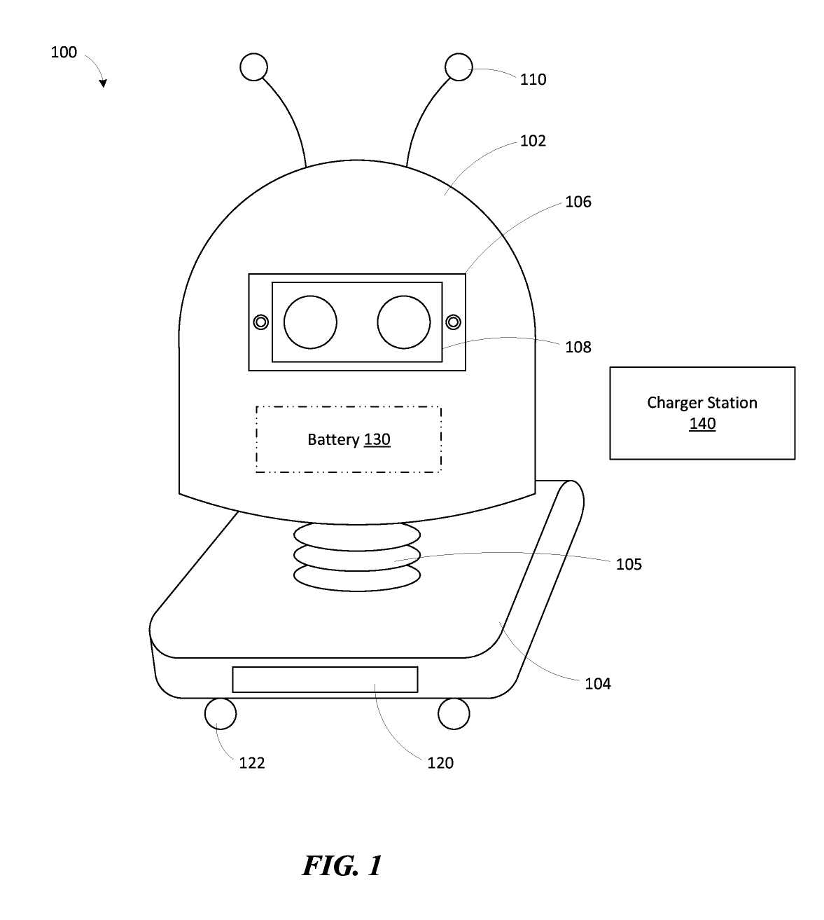

FIG. 1 is an illustrative diagram of a therapeutic robot 100, in accordance with various embodiments. The therapeutic robot 100 is designed and adapted to act as a playmate to a child to deliver developmental therapy to the child and to capture behavioral data to improve upon the developmental therapy.

The therapeutic robot 100 may include a head section 102 and a foot section 104, coupled together through a neck structure 105. The head section 102 may include a mobile device 106, such as a mobile phone, a personal digital assistant (PDA), or a mobile tablet. In one particular example, the mobile device 106 can be an iPhone™ or an iPod™. In some embodiments, the head section 102 and the foot section 104 are detachably coupled to one another such that a child or a guiding operator can separate the head section 102 from the foot section 104. In these embodiments, the head section 102 can still be controlled via the mobile device 106. This feature enables a child to bring a smaller, less heavy version of the therapeutic robot 100 into bed with them or to sit on his/her lap in class. Under these circumstances, the therapeutic robot 100 may have less features enabled than when the foot section 104 is attached.

In order to emulate the therapeutic robot 100 as a creature that a child is willing to bond with, a display 108 the mobile device 106 can render a facial feature of the creature, such as one or more eyes, a nose, one or more eyebrows, facial hair, or any combination thereof. In one particular example, the display 108 can render a pair of eyes that moves and maintain eye contact with the child. Further to emulate the creature, the head section 102 may include one or more ornaments 110, such as a horn, an antenna, hair, fur, or any combination thereof. To emulate different creatures, the facial feature of the creature and animations of the facial feature may be adjusted or re-configured to better bond with the child (e.g., how big the eyes are, how frequently to make eye contact with the child or how often the creature blinks).

The foot section 104 or the head section 102 may include one or more external devices 120 (i.e., external in the sense that it is controlled by the mobile device 106 and part of the therapeutic robot 100, but external to the mobile device 106) to facilitate interaction with the child. For example, the external devices 120 may include monitoring devices or sensors, such as an external camera, an external microphone, or a biofeedback sensor (e.g., a heart rate monitor). In some embodiments, the monitored condition and data via the external sensors can trigger behavior change or initiation of the therapeutic robot 100. The external devices 120 may also include mechanical devices, such as a mechanical arm, an actuator, or a motor. The external devices 120 may further include output devices, such as an external display or an external speaker. The external devices 120 may be coupled to the mobile device 106 wirelessly (e.g., via Wi-Fi or Bluetooth) or via a wired connection (e.g., via an audio cable, a proprietary cable, or a display cable).

The foot section 104 includes one or more movement devices 122. The movement devices 122 enable the therapeutic robot 100 to move from place to place. The movement devices 122, for example, can include a wheel, a robotic leg, a sail, a propeller, a mechanism to move along a track, tractor treads, a retracting hook, or any combination thereof. The foot section 104 may be compatible with multiple detachable movement devices, such as one or more movement devices for traversing carpet, one or more movement devices for traversing hardwood or tile floor, one or more movement devices for traversing outdoor terrain, or any combination thereof.

The mobile device 106 may function in two or more modes, such as an offline mode, a passive mode, an automatic interaction mode, or an active control mode. Under the off-line mode, the therapeutic robot 100 may remain inanimate with a power source electrically decoupled from all other components. Under the passive mode, the therapeutic robot 100 may continually monitor its environment including a presence of the child without interacting with the child or the environment and/or without moving. Under the automatic interaction mode, the therapeutic robot 100 may perform a set of preconfigured tasks (e.g., sing a song or ask the child a set of pre-configured questions), a set of random operations (e.g., speak random words or move about randomly), or any combination thereof. Under the automatic interaction mode, the therapeutic robot 100 may respond in a pre-configured fashion to certain stimulus measurable by the sensors of the mobile device 106 or sensors within the external devices 120. For example, the therapeutic robot 100 can respond to touch (e.g., petting) by blinking or whistling and respond to falling over by protesting or whining.

Under the active control mode, the mobile device 106 and thus components of the therapeutic robot 100 may be controlled by an external control device, such as an external mobile device (e.g., an iPad). The external control device may be operated by a parent, a therapist, or a teacher. The operator of the external control device may interact with the child through the therapeutic robot 100. For example, the operator may play a game with the child through the display 108 of the mobile device 106. Instruments of the game may be presented on the display 108, and the child may interact with such instruments and/or the operator of the external control device through any input devices including the display 108 as a touch screen, a camera of the mobile device 106, a microphone of the mobile device 106, or some of the external devices 120.

Other interactive games that require only a single human player may also be played using the therapeutic robot 100. In these cases, the child can play with or against an artificial intelligence implemented on the mobile device 106 or on the external control device. In various embodiments, the interaction data collected by the mobile device 106 includes performance data (e.g., button presses and success/completion rate of the interactive games) of the child engaging in the interactive games.

The therapeutic robot 100 can include a battery module 130. The battery module 130 powers at least a portion of the devices within the therapeutic robot 100, including the movement devices 122 and the external devices 120. In embodiments, an interface that couples the mobile device 106 to the therapeutic robot 100 enables the mobile device 106 to charge its battery from the battery module 130. In some embodiments, a charging station 140 can detachably connect with the battery module 130. For example, when the battery module 130 is low on power, the mobile device 106 or another controller in the therapeutic robot 100 can automatically direct the movement devices 122 towards the charging station 140 to connect with the charging station 140 and charge the battery module 130. In other embodiments, the mobile device 106 can display a notification on its own display, one of the displays of the external devices 120, or an external control device, when the battery module 130 is running low.

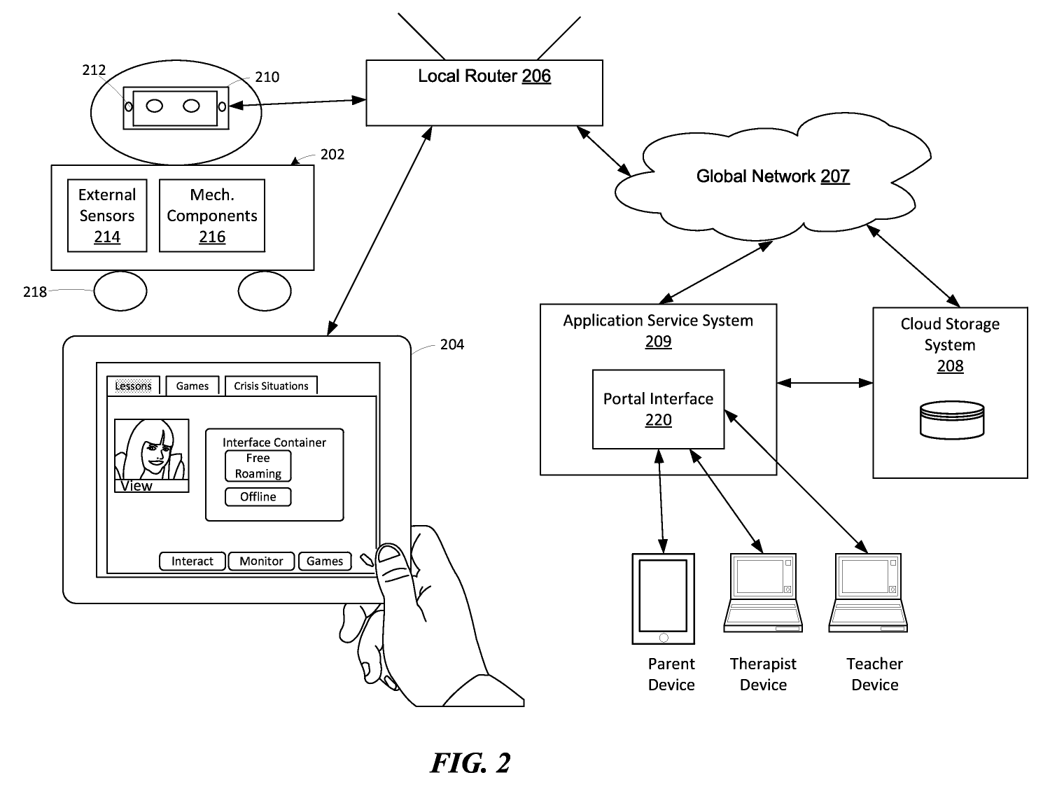

FIG. 2 is a data flow chart of a developmental monitoring system 200, in accordance with various embodiments. The developmental monitoring system 200 may include a therapeutic robot 202, such as the therapeutic robot 100 of FIG. 1, a local control device 204, a local router 206, a global network 207 (e.g., the Internet), a cloud storage system 208, and an application service system 209. The therapeutic robot 202 may include a first mobile device 210 embedded therein. The first mobile device 210 may be the mobile device 106 of FIG. 1. The first mobile device 210 implements an application (i.e., a set of digital instructions) that can control the therapeutic robot 202 to interact with a child on behalf of the developmental monitoring system 200.

The first mobile device 210 can record a number of raw inputs relevant to the child's behavior, such as photographs of the child, video feed of the child, audio feed of the child, or motion data. In order to record the raw inputs, for example, the first mobile device 210 may use internal sensors 212 within the first mobile device 210. For example, the internal sensors 212 may include a gyroscope, an accelerometer, a camera, a microphone, a positioning device (e.g., global positioning system (GPS)), a Bluetooth device (e.g., to determine presence and activity of nearby Bluetooth enabled devices), a near field communication (NFC) device (e.g., to determine presence and activity of nearby NFC devices), or any combination thereof.

The first mobile device 210 may also use external sensors 214 away from the first mobile device 210 but within the therapeutic robot 202. The first mobile device 210 may also analyze the raw inputs to determine behavioral states of the child, such as whether or not the child is paying attention, emotional state of the child, physical state of the child, or any combination thereof.

The first mobile device 210 may be in wireless communication with the local control device 204, such as via Wi-Fi or Bluetooth. The local control device 204 may be a mobile tablet device or a laptop. The local control device 204 can select which mode the therapeutic robot 202 is operating in, such as the modes described above. For example, under an active control mode, the local control device 204 can receive a live multimedia stream from the internal sensors 212 or the external sensors 214. The local control device 204 can also move or actuate the therapeutic robot 202 by controlling mechanical components 216 of the therapeutic robot 202 including its wheels/legs 218. The local control device 204 can also determine what to present on an output device of the first mobile device 210 or an external output device (not shown) controlled by the first mobile device 210.

The live multimedia stream presented on the local control device 204 may be of a lower resolution than the native resolution as recorded. However, the multimedia segments may be uploaded asynchronously (i.e., not in real-time) to a cloud storage system 208 via the local router 206 through the global network 207. Other interaction data or calculated behavioral states known to either the first mobile device 210 or the local control device 204 may be uploaded to the cloud storage system 208 from the respective devices. For example, interaction data may include a motion record of what is happening to the therapeutic robot 202 and input data through input devices of the therapeutic robot 202. The interaction data may also include an association of behavior and/or instructions being executed through the therapeutic robot 202 at the time the input data and the motion record are captured.

The application service system 209 may be in communication with the cloud storage system 208 either through the global network 207 or via a local/private network. The application service system 209 can provide a portal interface 220, for example, on a subscription basis. The application service system 209 can generate a developmental log for the child based on the uploaded multimedia segments, interaction data, and/or calculated behavioral states. The portal interface 220 may be accessible by different types of user accounts, such as a parent account, a therapist account, or a teacher account. Each type of user account may be associated with different privileges and accessibility to the developmental log, including viewing privileges, tagging privileges (i.e., ability to tag portions of the developmental log), persistent storage privileges, or editing/deletion privileges.

The application service system 209 may also run a detection system to detect signs or evidence of potential developmental disabilities or disorders. For example, developmental disorders may include a developmental delay of a motor function (e.g., favoring a left arm over a right arm), a lack of social engagement (e.g., lack of eye contact), short attention span, violent behavior, irritability, or inability to perform repeated task. The detection system may be implemented by building machine learning models based on observable features in interaction data, behavioral states, and multimedia segments. For example, for each disability or disorder, a machine learning model may be built based on the interaction data, the multimedia segments, and the behavioral states of known cases of the disability or disorder. The detection system can then run the currently observed interaction data, multimedia segments, and behavioral states against the machine learning models. Once the sign and/or evidence of the potential developmental disability or disorder is detected, a portion of the developmental log can be tagged such that subscribed users can review and diagnose the child based on the portion tagged.

It is noted while the developmental monitoring system 200 is intended for providing therapy for children, the techniques and mechanisms disclosed may also apply to provide therapy for adults, elderly, physical or mentally disabled, or pets.

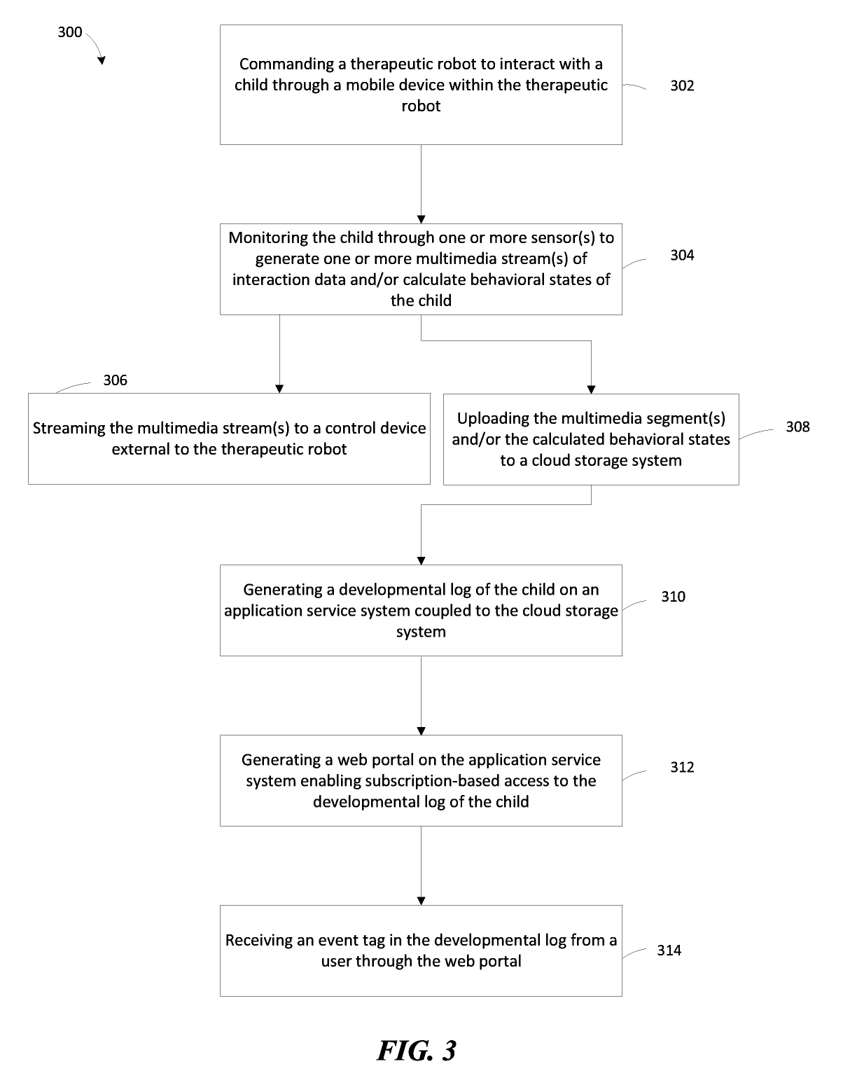

FIG. 3 is flow chart of a process 300 of storing data reported from a therapeutic robot, in accordance with various embodiments. The process includes commanding a therapeutic robot to interact with a child through a mobile device within the therapeutic robot in step 302. While the therapeutic robot is interacting with the child, the mobile device can monitor the child through one or more sensor(s) to generate one or more multimedia stream(s) of interaction data and/or calculate behavioral states of the child in step 304. While monitoring, the mobile device can streaming (e.g., in real-time) the multimedia stream(s) to a control device external to the therapeutic robot in step 306. The streaming may be made at a lower resolution than the native resolution captured by the sensor(s) to reduce network workload. The control device can be another mobile device wirelessly connected to the mobile device in the therapeutic robot through a local router.

After a set period of monitoring, the mobile device can upload one or more segments of the multimedia stream(s) and/or the calculated behavioral states to a cloud storage system for persistent storage in step 308. For example, the multimedia streams(s) may include a video stream, an audio stream, an audio video (A/V) stream, or a touch input stream (e.g., from a touchscreen of the mobile device). For example, the behavioral states may include amount of physical contact the child has with the therapeutic robot, an average volume of ambient noise, an average volume of the child, frequency that the child interacts with the therapeutic robot, frequency that the child verbalizes, or average pitch of the child's voice. As another example, the behavioral states may include linguistic analysis measurements, such as the portion of the child's verbalization that are known words vs. non-sense utterances.

In some embodiments, the multimedia stream(s) and/or the calculated behavioral states may be uploaded from the control device. The behavioral states may be calculated by the mobile device or the control device. In the case that the behavioral states are calculated by the mobile device, the behavioral states can also be streamed in real-time to the control device during step 306.

As the cloud storage system accumulates the multimedia streams and/or the calculated behavioral states related to the child, an application server system coupled to the cloud storage system can generate a developmental log of the child in step 310. The developmental log may include the multimedia files organized in a temporal timeline. The developmental log may also include the behavioral states organized in the same timeline. In some embodiments, the behavioral states are not calculated by the control device nor the mobile device, but instead are calculated by the application service system once the raw data becomes available on the cloud storage system.

In step 312, the application service system may generate a web portal enabling subscription-based access to the developmental log. With the web portal, a subscribed user can diagnose the child by viewing the developmental log. The subscribed user may also extract multimedia segments from the developmental log for personal keeping or for sharing on a social media website. The subscribed user may also tag portions of the developmental log to signify a developmental event, an evidence of developmental disorder, or just a memorable event. For example, the application service system may receive an event tag in the developmental log through the web portal in step 314. The event tag may include an event description tag, a developmental disorder evidence tag, a mark-for-review tag, a mark-for-storage tag, a mark-for-deletion tag, or a completed-review tag.

While processes or blocks are presented in a given order in FIG. 3, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

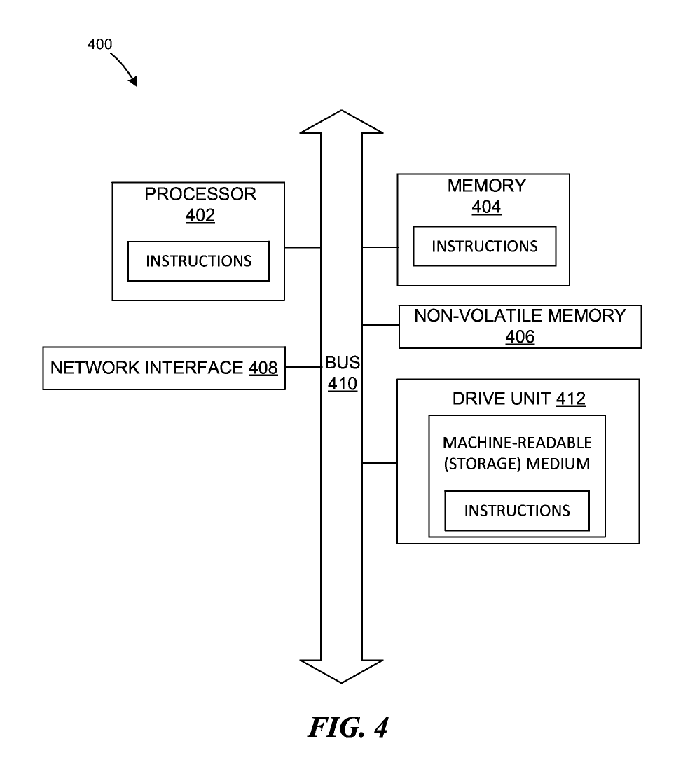

FIG. 4 is a block schematic diagram that depicts a machine in the exemplary form of a computer system 400 within which a set of instructions for causing the machine to perform any of the herein disclosed methodologies may be executed. In alternative embodiments, the machine may comprise or include a network router, a network switch, a network bridge, personal digital assistant (PDA), a cellular telephone, a Web appliance or any machine capable of executing or transmitting a sequence of instructions that specify actions to be taken. The computer system 400 is intended to illustrate a hardware device on which any of the instructions, processes, modules and components depicted in the examples of FIGS. 1-3 (and any other processes, techniques, modules and/or components described in this specification) can be implemented. As shown, the computer system 400 includes a processor 402, memory 404, non-volatile memory 406, and a network interface 408. Various common components (e.g., cache memory) are omitted for illustrative simplicity. The computer system 400 can be of any applicable known or convenient type, such as a personal computer (PC), server-class computer or mobile device (e.g., smartphone, card reader, tablet computer, etc.). The components of the computer system 400 can be coupled together via a bus and/or through any other known or convenient form of interconnect.

One of ordinary skill in the relevant art will recognize that the terms “machine-readable (storage) medium” or “computer-readable (storage) medium” include any type of device that is accessible by the processor 402. The memory 404 is coupled to the processor 402 by, for example, a bus 410. The memory 404 can include, by way of example but not limitation, random access memory (RAM), such as dynamic RAM (DRAM) and static RAM (SRAM). The memory 404 can be local, remote, or distributed.

The bus 410 also couples the processor 402 to the non-volatile memory 406 and drive unit 412. The non-volatile memory 406 may be a hard disk, a magnetic-optical disk, an optical disk, a read-only memory (ROM), such as a CD-ROM, Erasable Programmable Read-Only Memory (EPROM), or Electrically Erasable Programmable Read-Only Memory (EEPROM), a magnetic or optical card, or another form of storage for large amounts of data. The non-volatile storage 406 can be local, remote, or distributed.

The modules or instructions described for FIGS. 1-3 may be stored in the non-volatile memory 406, the drive unit 412, or the memory 404. The processor 402 may execute one or more of the modules stored in the memory components.

The bus 410 also couples the processor 402 to the network interface device 408. The interface 408 can include one or more of a modem or network interface. A modem or network interface can be considered to be part of the computer system 400. The interface 408 can include an analog modem, ISDN modem, cable modem, token ring interface, satellite transmission interface (e.g., “direct PC”), or other interfaces for coupling a computer system to other computer systems.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g., a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

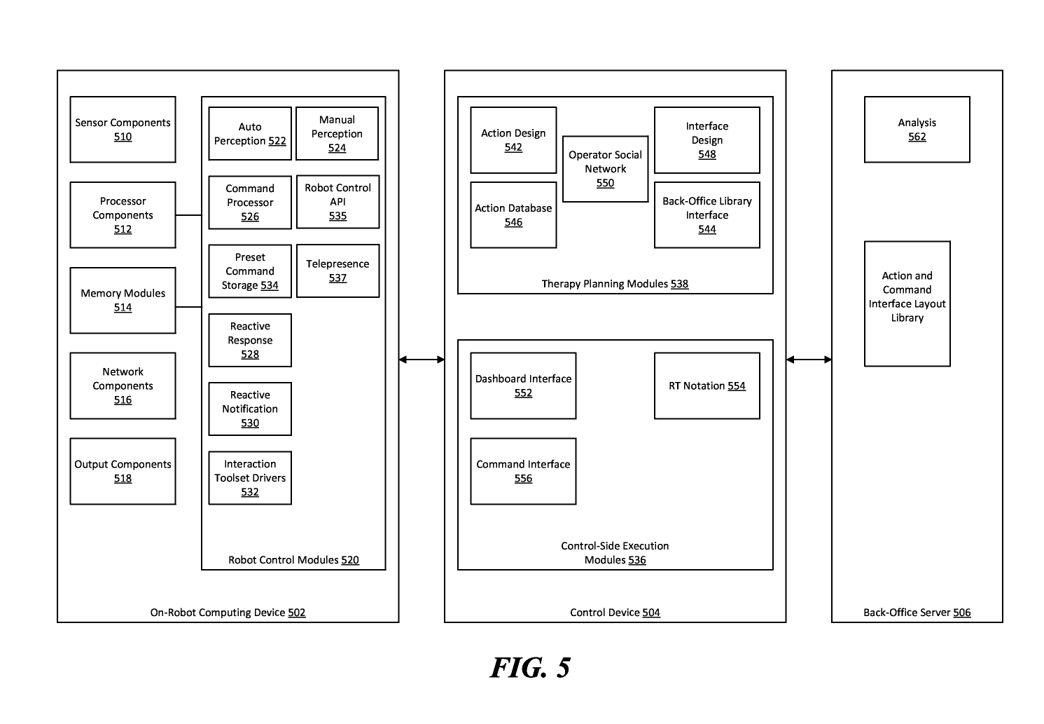

FIG. 5 is a block diagram illustrating a system architecture of a therapeutic robotics system 500. For example, the therapeutic robotics system 500 can include at least an on-robot computing device 502, such as the mobile device 106 of FIG. 1 or the first mobile device 210 of FIG. 2, a control device 504, such as the local control device 204 of FIG. 2, and a back-office server 506, such as the application service system 209 of FIG. 2.

The on-robot computing device 502 may be a detachable mobile device that is coupled to a therapeutic robot (not shown). The on-robot computing device 502 can include one or more sensor components 510, one or more processor components 512, one or more memory modules 514, one or more network components 516, one or more output components 518 (e.g., display, speaker, or vibration generator), or any combination thereof. The sensor components 510 facilitate capturing of data when the therapeutic robot is interacting with a child, such as during a therapy session. The processor components 512 can execute one or more applications that emulate an intelligent agent and execute commands and instructions from the control device 504. The memory modules 514 can store the data captured by the sensors, command scripts from the control device 504, and program modules for execution by the processors. The network components 516 enable the on-robot computing device 502 to communicate with external components in the therapeutic robot, the control device 504, the back-office server 506, or other devices. For example, the therapeutic robot can have other components, active or passive, that are controlled by the on-robot computing device 502 through the network components 516. The output components 518 may be used to communicate with a child. For example, a display can be used to show an emulation of a pair of eyes. A speaker can be used to produce noise or speech.

The memory modules 514 can include various robot control modules 520 for execution by at least one of the processor components 512. For example, the robot control modules 520 may include an automatic perception module 522, a manual perception module 524, a command processor module 526, a reactive response module 528, a reactive notification module 530, interaction toolset drivers 532, or any combination thereof. The robot control modules 520 may also include a preset command storage 534, such as a database or a mapping file. The preset command storage 534 can include sequences of instructions to one or more components in or controlled by the on-robot computing device 502. These command sequences can enable a guiding operator of the therapeutic robotics system 500 to demand actions from components of the therapeutic robot that are designed to facilitate a therapy session.

The automatic perception module 522 is configured to automatically detect contextual events based on data collected by the sensor components 510 in the on-robot computing device 502 or other sensors in the therapeutic robot. For example, the automatic perception module 522 can detect that the therapeutic robot is being violently shaken by a child by monitoring data from an accelerometer in the on-robot computing device 502. As another example, the automatic perception module 522 can detect that a child is making eye contact with the therapeutic robot based on eye tracking of the child via one or more cameras in the on-robot computing device 502 or elsewhere in the therapeutic robot. As yet another example, the automatic perception module 522 can detect aggressive behaviors from a child based on volume levels detected via one or more microphones in the on-robot computing device 502 or elsewhere in the therapeutic robot. Other examples include detection of a child's laughter or other emotional expressions, absence of engagement with the therapeutic robot, or specific interactions with the therapeutic robot (e.g., petting, poking, punching, hugging, lifting, etc.).

The manual perception module 524 is configured to detect contextual events, in response to a command from the control device 504, based on data collected by the sensor components 510 or other sensors in the therapeutic robot. Certain contextual events can be more easily spotted by an expert, such as the guiding operator of the therapeutic robotics system 500. The manual perception module 524 enables the guiding operator to command the on-robot computing device 502 to look for a specific contextual event within a period of time or substantially immediately after receiving the command.

The automatic perception module 522 and the manual perception module 524 can use a variety of tools to analyze an environment external to the therapeutic robot. For example, the modules can use stereo cameras and/or stereo microphones to gain a spatial perception of where a child is around the therapeutic robot.

When a contextual event is detected by the automatic perception module 522 or the manual perception module 524, the on-robot computing device 502 can record the contextual event for later analysis, execute a sequence of commands in response, notify the control device in response, or any combination thereof. The reactive response module 528 can maintain a table associating contextual events to commands or sequences of commands to one or more components in or controlled by the on-robot computing device 502. For example, in response to detecting that a child is about to poke or has poked eyes rendered on a display of the on-robot computing device 502, the reactive response module 528 can execute a sequence of commands for the therapeutic to say “ouch” via a speaker and render an eye blinking animation on the display.

The reactive notification module 530 can maintain a table associating contextual events to messages, including messages to the control device 504, the back-office server 506, or one of the display components in or controlled by the on-robot computing device 502. For example, in response to detecting aggressive/violent interactions between a child and the therapeutic robot, the reactive notification module 530 can push an interrupt message to the control device 504. The interrupt message can be used to notify a guiding operator of the therapeutic robotics system 500 that the child is being violent. The interrupt message can also be automatically stored in a log file that is associated with a therapy session.

The command processor module 526 is configured to receive command messages from the control device 504 (e.g., generated by a guiding operator of the control device 504) and execute commands or sequences of commands based on the command messages. For example, the command processor module 526 can access mappings between command identifiers and instructions to one or more components in or controlled by the on-robot computing device 502. The mappings can also be between command identifiers and the sequences of instructions in the preset command storage 534.

The interaction toolset drivers 532 enable a guiding operator of the control device 504 to communicate through the therapeutic robot. For example, the interaction toolset drivers 532 can enable the guiding operator to speak through the on-robot computing device 502, such as by real-time or asynchronous streaming of audio data or text data (e.g., when using a text-to-speech program to generate the speech). The interaction toolset drivers 532 can also enable the guiding operator to draw on one or more displays in the therapeutic robot. In another example, the interaction toolset drivers 532 can enable the guiding operator to drive and navigate the therapeutic robot (e.g., on its legs, tracks, or wheels).

Specifically, the interaction toolset drivers 532 can include a text-to-speech module and/or a speech-to-speech module. The text-to-speech module can produce sound based on text sent from the control device 504. The speech-to-speech module can produce sound based on audio data sent from the control device 504. Voices produced from the text-to-speech can be configured with a speaker profile (e.g., accent, gender, age, etc.) and an emotional state (e.g., excited, relaxed, authoritative, etc.). Voices produced from the speech-to-speech module can be modulated, such as modulated in accordance with an emotional state or a speaker profile.

In some embodiments, the robot control modules 520 include an robot control application programming interface (API) module 535. The robot control API module 535 enables third party applications to have limited control of the behavior and actions of the therapeutic robot. For example, when a child completes a puzzle game in a game application, the puzzle game can make the therapeutic robot spin in a circle and whistle joyfully.

In some embodiments, the control device 504 resides in a location far away from the therapeutic robot. In those embodiments, the robot control modules 520 can include a telepresence module 537. The telepresence module 537 enables a guiding operator to interact with children through the therapeutic robot in hard to access geographical areas. In some embodiments, the telepresence module 537 can also enable children to control the therapeutic robot themselves.

The control device 504 is configured to provide one or more interfaces for a guiding operator of the therapeutic robotics system 500 to design and execute interactive sessions to help a child to develop and grow. The control device 504, for example, can be a mobile device, such as a tablet or a laptop. The control device 504 can include one or more processors and one or more memory modules. The control device 504 can execute program modules in the memory modules via the one or more processors. For example, the program modules may include control-side execution modules 536 and therapy planning modules 538.

The control-side execution modules 536 and the therapy planning modules 538 are programs and applications that configure the control device 504 to provide the interfaces to a guiding operator. It is noted that while the therapy planning modules 538 are illustrated to be implemented on the control device 504, in other embodiments, one or more of the therapy planning modules 538 can be implemented on other devices as well, including the back-office server 506, other web service servers, or other mobile devices.

The therapy planning modules 538 can include an action design module 542. The action design module 542 is configured to provide an action design interface to create and organize command actions for the therapeutic robot. For example, the action design module 542 can provide an interface to combine existing commands in series into a new action. The action design interface can provide a list of existing commands. The list of existing commands can be preconfigured into the therapy planning modules 538. The list of existing commands can also be accessible from the back-office server 506 via a back-office library interface 544. Existing commands may include driving the therapeutic robot in a straight line, producing a laughter noise from the therapeutic robot, producing a song from a speaker of the therapeutic robot, etc. The action design module 542 can also provide an interface to configure an existing command. For example, the action design module 542 can enable an operator to input a text to configure a text-to-speech command. For another example, the action design module 542 can enable an operator to record an audio clip to configure a pre-recorded multimedia playing command. An operator can further edit any multimedia file that is configured to play on demand. For example, the operator can pre-modulate an audio clip to change the vocal characteristic of an audio recording. These sequences of commands and configured commands can be stored in an action database 546 to be later referenced through a command interface to facilitate real-time puppeteering of the therapeutic robot.

The therapy planning modules 538 can also include an interface design module 548. The interface design module 548 is configured to provide an “interface design interface.” The interface design interface enables an operator to design user interfaces that can be used during active sessions involving the therapeutic robot and at least one child. For example, a designing operator can create and layout buttons or other widgets (e.g., a slider, a grid, a map, etc.) for the interfaces. The buttons and widgets can be categorized within interface containers, such as windows, tabs, lists, panels, menus, etc. Through the interface design interface, the designing operator can associate the buttons or widgets with existing commands to the therapeutic robot or the actions stored in the action database 546.

The guiding operator can pre-populate a command interface via the interface design interface. Each instance of the command interface can be organized in one of the interface containers. For example, the command interface can be organized by names of specific children, names of specific operators, labels of specific situations with a child (e.g., “crying,” “pouting,” “yelling,” “laughing,” other emergency or crisis situations, etc.), specific goals of an active session (e.g., improving attention span, obedience, socialization, eye contact, physical skills, verbalizing skills, etc.), labels of specific lessons, sessions, or games (e.g., a math lesson, an empathy lesson, an art therapy session, a question and answer (Q&A) session, an “I spy” game, a “musical chair” game, etc.), or any combination thereof. The designing operator can further color code and size, via the interface design interface, interface elements (e.g., widgets and buttons) within the designed command interface.

In various embodiments, the interface design module 548 can associate gestures with commands to the on-robot computing device 502. Gestures can be touchscreen gestures (e.g., specific movement patterns on a touchscreen of the control device 504) or spatial gestures (e.g., specific movement patterns, such as waving a hand, covering an eye, or giving a thumbs up, captured from stereo cameras of the control device 504). The interface design module 548 can also associate audio patterns (e.g., by performing pattern recognition on audio data captured by a microphone of the control device 504) with commands to the on-robot computing device 502. The interface design module 548 can also associate other patterns with commands to the on-robot computing device 502. For example, other patterns include a movement pattern of the control device 504 as detected by an accelerometer in the control device 504.

The therapy planning modules 538 may also include an operator social network module 550. The operator social network module 550 provides a social network interface for operators, who have designed actions through the action design interface, to share the designed actions with other operators. The social network interface also enables the operators, who have designed command interfaces, to share the layout of the command interfaces with other operators. The social network interface further enables the operators to comment on the actions or layouts and vote on the actions or layouts. In various embodiments, the interface layout, the lesson plans, and the designed actions can be shared or sold through the operator social network module 550.

In some embodiments, the therapy planning modules 538 can be used to design configurations of lessons to teach the guiding operator to deliver therapy lessons through the designed actions and the designed command interfaces. For example, these configurations can be used to teach an amateur therapist or a parent to act as the guiding operator.

In some embodiments, the therapy planning modules 538 can be used to create interfaces for children to control the therapeutic robot. These interfaces can have limited amount of functionalities as compared to a guiding operator.

The control-side execution modules 536 include at least a dashboard interface 552, a real-time notation module 554, and a command interface 556. The dashboard interface 552 is configured to display sensor data from the on-robot computing device 502 and/or contextual events detected via the automatic perception module 522 or the manual perception module 524.

The command interface 556 is configured with buttons and/or widgets that can send commands in real-time to the on-robot computing device 502. For example, the buttons or widgets can cause commands to be sent from the control device 504 to the command processor module 526 of the on-robot computing device 502. The layout of the buttons and/or widgets may be categorized into different interface containers. The layout can be configured by the interface design module 548. For example, the command interface can be organized by names of specific target children, names of specific operators, labels of specific situations with a child (e.g., “crying,” “pouting,” “yelling,” “laughing,” other emergency or crisis situations, etc.), specific goals of an active session (e.g., improving attention span, obedience, socialization, eye contact, physical skills, verbalizing skills, etc.), labels of specific lessons, sessions, or games (e.g., a math lesson, an empathy lesson, an art therapy session, an “I spy” game, a “musical chair” game, etc.), or any combination thereof. The command interface 556 can further enable a guiding operator to send commands to the on-robot computing device 502 by using other shortcuts, such as gestures (e.g., swipes or taps on a touchscreen), voice instructions (e.g., via audio pattern recognition), or other patterns as captured by sensors of the control device 504.

The real-time notation module 554 is configured to provide a notation interface for a guiding operator of the control device 504 to notate data relating to an active session of therapy or lesson. The real-time notation module 554 also records a timed history of commands sent to the on-robot computing device 502 during the active session.

In some embodiments, the notation interface can associate quick successions of one or more taps on a touch screen of the control device 504 with enumerated notes. For example, the notation interface can be configured such that whenever the guiding operator taps once on the control device 504, the control device 504 records the time of the tap with an enumerated note of “the child became calmer.” Alternatively, the control device 504 can associate the enumerated note with the last command sent to the on-robot computing device 502. In another example, the real-time notation interface can be configured such that whenever the guiding operator double taps the control device 504, the control device 504 records the time of the double tap with an enumerated note of “the child obeyed instructions.”

The disclosed notation interface advantageously provides a way for guiding operators to record notes relating to active sessions when he/she is actively engaged with a child. An active session may involve an operator, a target child, a therapeutic robot, and other spectators or participants. During the active session, the operator, such as a therapist, may be distracted by many centers of attention, including the target child, interfaces on the control device 504, the therapeutic robot, and the other participants. Hence ordinarily, the operator hardly has enough time to log any notes relating to the active session. For example, the operator may want to write down what phrases uttered by the therapeutic robot can make a child happy. By enabling a quick way to associate enumerated notes with a command or a time, the operator can better record findings in an active session without worrying about getting distracted.

The back-office server 506 includes at least an analysis module 562. At least a portion of the inputs and outputs through the modules of the control device 504 and/or the on-robot computing device 502 can be uploaded to the back-office server 506. For example, data stored via the real-time notation module 554 can be uploaded to the back-office server 506. As another example, the video or audio data recorded via the sensor components 510 can also be uploaded to the back-office server 506. The analysis module 562 can provide an interface to facilitate a post-session analysis. For example, the analysis interface can enable playback of multimedia recordings of an active session aligned with any notations captured via the real-time notation module 554. The analysis interface can facilitate diagnosis and goal validation as well.

Regarding FIG. 5, portions of the illustrated components and/or modules may each be implemented in the form of special-purpose circuitry, or in the form of one or more appropriately programmed programmable processors, or a combination thereof. For example, the modules described can be implemented as instructions on a tangible storage memory capable of being executed by a processor or a controller. The tangible storage memory may be volatile or non-volatile memory. In some embodiments, the volatile memory may be considered “non-transitory” in the sense that it is not transitory signal. Modules may be operable when executed by a processor or other computing device, e.g., a single board chip, application specific integrated circuit, a field programmable field array, a network capable computing device, a virtual machine terminal device, a cloud-based computing terminal device, or any combination thereof. Memory spaces and storages described in the figures can be implemented with tangible storage memory, including volatile or non-volatile memory.

Each of the modules and/or components may operate individually and independently of other modules or components. Some or all of the modules in one of the illustrated devices may be executed on another one of the illustrated devices or on another device that is not illustrated. The separate devices can be coupled together through one or more communication channels (e.g., wireless or wired channel) to coordinate their operations. Some or all of the components and/or modules may be combined as one component or module.

A single component or module may be divided into sub-modules or sub-components, each sub-module or sub-component performing separate method step or method steps of the single module or component. In some embodiments, at least some of the modules and/or components share access to a memory space. For example, one module or component may access data accessed by or transformed by another module or component. The modules or components may be considered “coupled” to one another if they share a physical connection or a virtual connection, directly or indirectly, allowing data accessed or modified from one module or component to be accessed in another module or component. In some embodiments, at least some of the modules can be upgraded or modified remotely. The on-robot computing device 502, control device 504, and the back-office server 506 may include additional, fewer, or different modules for various applications.

What is claimed is:

1. A method comprising:
commanding a therapeutic robot to interact with a child through a mobile device within the therapeutic robot;
monitoring the child through one or more sensors to generate one or more multimedia segments of interaction data, wherein the sensors are in mobile device or in the therapeutic robot;
uploading the multimedia segments to a cloud storage system; and
generating a developmental log of the child on an application service system coupled to the cloud storage system based on the uploaded multimedia segments.

2. The method of claim 1, further comprising:
calculating behavioral states via the mobile device based on interaction data from the one or more sensors; and
uploading the behavioral states to the cloud storage system; and
wherein generating the developmental log includes generating the developmental log based on the calculated behavioral states.

3. The method of claim 1, further comprising:
calculating behavioral states via the application service system based on the interaction data from the one or more sensors; and
wherein generating the developmental log includes generating the developmental log based on the calculated behavioral states.

4. The method of claim 1, further comprising streaming the multimedia segments in real-time to a control device external to the therapeutic robot to enable an operator of the control device to control the therapeutic robot in real-time.

5. The method of claim 1, further comprising generating a web portal on the application service system to provide subscription-based access to the developmental log of the child.

6. The method of claim 5, further comprising receiving an event tag in the developmental log from a user through the web portal.

7. A method comprising:
configuring an action script to command a mobile device controlling a therapeutic robot for interacting with a child through the therapeutic robot;
associating the action script with an interface shortcut;
configuring a layout of a command interface including interface containers associated contextual situations when the therapeutic robot is interacting with the child, wherein the command interface includes the interface shortcut; and
generating the command interface based on the configured layout.

8. The method of claim 7, further comprising generating an action design interface to facilitate configuring of the action script.

9. The method of claim 8, wherein the action design interface provides an interface to serially combine existing commands to generate a new action.

10. The method of claim 9, wherein the existing commands include driving the therapeutic robot, producing a laughter noise, playing a song, or any combination thereof.

11. The method of claim 7, wherein configuring the action script includes receiving an input text to configure a text-to-speech command that commands the therapeutic robot to produce speech based on the input text.

12. The method of claim 7, further comprising organizing commands in the command interface based on identities of target audiences, identities of operator of the therapeutic robot, situational context, goals of an active session of robotic therapy, labelings of lesson plans, or any combination thereof.

13. A robot comprising:
a head section configured to interface with a mobile device to control the robot;
a tail section comprising:
a movement device controlled by the mobile device; and
a battery to power the movement device; and
a furry exterior to emulate an intelligent pet; and
wherein the head section and the tail section in combination is smaller than a human toddler.

14. The robot of claim 13, wherein the movement device is configured to move slower than an average human child.

15. The robot of claim 13, further comprising the mobile device configured by executable instructions to:
communicate with a control device enabling a guiding operator to puppeteer the robot through the mobile device.

16. The robot of claim 15, wherein the mobile device is operable in two or more modes including: a combination of an offline mode, a passive mode, an automatic interaction mode, or an active control mode.

17. The robot of claim 15, wherein the mobile device implements an automatic perception module configured to detect contextual events automatically based on data collected by a sensor in the mobile device or elsewhere in the robot.

18. The robot of claim 15, wherein the mobile device implements a manual perception module configured to detect contextual events, in response to a command from the control device, based on data collected by a sensor in the mobile device or elsewhere in the robot.

19. The robot of claim 15, wherein the mobile device implements an interaction toolset driver configured to enable a human operator to communicate wirelessly with an audience through the robot.

20. The robot of claim 13, further comprising an actuator, a motor, a speaker, a display, or any combination thereof, to emulate gesture and behavior of an intelligent being.
